(19) United States
(12) Patent Application Publication
(10) Pub. No.: US 2013/0146110 A1
(43) Pub. Date: Jun. 13, 2013

(54) POLE HAVING A SHOCK ABSORBER

(71) Applicants: Eberhard Heim, Unterensingen (DE); Marco Hofer, Deggingen (DE)

(72) Inventors: Eberhard Heim, Unterensingen (DE); Marco Hofer, Deggingen (DE)

(73) Assignee: LEKISPORT AG, Baar (CH)

(21) Appl. No.: 13/704,068

(22) PCT Filed: Jun. 6, 2011
(86) PCT No.: PCT/EP11/59265

§ 371 Date: Feb. 27, 2013

(30) Foreign Application Priority Data
Jun. 14, 2010 (CH) 00948/10

(51) Int. Cl. F16F 15/02; A63C 11/22; F16F 7/00; A45B 9/00

(52) U.S. Cl. CPC F16F 15/02; A45B 9/00; A63C 11/221; F16F 7/00
USPC 135/65; 267/136; 280/819

(57) ABSTRACT

The invention relates to a damping device (1) for a pole, in particular a trekking, ski, hiking, or Nordic walking pole, having an attaching sleeve (4) by means of which the damping device (1) is attached to a first tube segment (11, 44) by inserting and attaching therein, and having an attaching element (3) by means of which the damping device (1) is attached to a pole handle (5) or a second tube segment (43) having a larger inner diameter than the first tube segment (11, 44). The attaching element (3) is thereby movably supported in a spring-loaded manner in the axial direction with respect to the attaching sleeve (4), in that a rod (2) connected to or integral to the attaching element (3) runs axially and is axially movably supported in the attaching sleeve (4) and extends into an inner chamber (46) in the attaching sleeve (4) open to the attaching element (3), wherein the inner chamber (46) is designed as a blind hole and at least one spring element (20-23) is disposed between the floor (47) and the free end of the rod (2). According to the invention, the attaching sleeve (4) thereby comprises an attaching segment (14) forming the end opposite the attaching element (3) and substantially lying completely within the first tube segment (11, 44), and an exposed region (16) facing the attaching element (3) and protruding past the free end of the first tube segment (11, 44). At least one guide element (7, 8) is also disposed in said exposed region (16) and both bounds the axial movability of the attaching sleeve (4) and attaching element (3) in the axial direction and substantially prevents the relative rotation of said two elements, and the rod (2) is further made of a plastic material at least in the region engaging with the attaching sleeve (4).

### TECHNICAL FIELD

The present invention relates to a pole such as for example a trekking, ski, hiking, or Nordic walking pole which comprises a pole handle, a pole tube and a pole tip. Respectively adjacent pole segments can be adjustable relative to one another. The pole according to the invention has a damping device with a guide sleeve held in a rotationally fixed manner in which a rod is guided axially movably.

### PRIOR ART

Various poles with shock absorbers are known from the prior art, thus for example in DE-U-298 13 601 and CH 680 771 A5, which however both enable only a relatively hard shock absorption. EP 1 435 805 B1 discloses a pole with damping whose shock characteristics are less hard thanks to a special serial arrangement of the compression spring device and whose rebound properties are less jerky and free from kickback compared to the first two mentioned documents.

Known from EP 1327468 is a damper structure for damping inside a pole handle in which a sleeve except for a flange is mounted in an inner tube where this sleeve has a blind hole open at the top. On the other side, a rod is attached to the pole handle which slides in this blind hole and a spiral spring is disposed between rod and floor of the blind hole. In other words, the suspension is mounted completely inside the inner tube as well as a corresponding mechanism which delimits the axial movability of rod and sleeve. This has the disadvantage that this mechanism is only accessible while the sleeve is not fixed in the inner tube.

WO 2009/003298 relates to a pole such as, for example, a trekking, ski, hiking, or Nordic walking pole which comprises a pole handle, a pole tube comprising at least three telescopic tubular sections, and a pole tip. Two adjacent pole sections are each adjustable relative to one another. The pole has a damping device with compression spring device, where an axial pin held axially fixedly on a second tubular section is guided in a guide sleeve held in a rotationally fixed manner in a first tubular section. Here also the suspension is located completely inside the inner tube in precisely the same way as a corresponding mechanism which delimits the axial movability of rod and sleeve.

### DESCRIPTION OF THE INVENTION

It is accordingly the object of the present invention to provide an improved damping device for a pole, for example, a trekking, ski, hiking, or Nordic walking pole. This can comprise a damping device which is formed between two tube segments which are arranged displaceably and adjustably and which slide into one another with a spreading device (telescopic poles) but this can also comprise a damping device which is disposed directly on the pole handle, specifically in the inside of the pole handle, and provides a suspension. Such a suspension in the pole handle can be used both in conventional non-adjustable poles and also in telescopic poles. In particular in the latter when these have external clamping mechanisms for the adjustment of the tube section relative to one another since suspensions cannot be provided so easily with these adjusting mechanisms.

Normally such a damping device comprises an attaching sleeve by means of which the damping device is attached to a first tube segment by inserting and attaching therein. In addition, this damping device normally comprises an attaching element by means of which the damping device is attached to a pole handle or a second tube segment having a somewhat larger inner diameter than the outer diameter of the first tube segment.

At the same time the attaching element is movably supported in a spring-loaded manner in the axial direction with respect to the attaching sleeve, whereby an axially running rod connected to or integral to the attaching element is provided, which rod is axially movably supported in the attaching sleeve and extends into an inner chamber in the attaching sleeve open to the attaching element. The inner chamber is designed as a blind hole and at least one spring element is disposed between the floor of the blind hole and the free end of the rod. According to the invention, the attaching sleeve comprises an attaching segment forming the end opposite the attaching element which substantially lies completely within the first tube segment, and an exposed region facing the attaching element which protrudes past the free end of the first tube segment. In the transition between the attaching segment and the exposed region, there is typically circumferential shoulder which expands the outside diameter in the form of a step, on which the circumferential edge of the first tube segment comes to a stop.

At the same time, at least one guide element is disposed in said exposed region which limits both the axial movability of attaching sleeve and attaching element in the axial direction and substantially prevents the relative rotation of said two elements. The damping element can thus be produced as a separate assembly and then combined with tube and/or additional tube or handle.

Furthermore, the rod preferably consists of metal or a plastic material at least in the region engaging in the attaching sleeve. In fact such rods in damping devices of the prior art are conventionally always made of metal since it was always assumed that the corresponding axial and torsional forces can only be intercepted by such materials. In addition, such rods were conventionally made of metal since the known damping devices of the prior art each have a spreading element of an adjustable clamping device as attaching element and in these it is necessary for the uppermost region of the rod to have an external thread. Such external threads can be manufactured almost only from metal materials so that the required easy running of the adjusting mechanism is ensured. As the present invention shows, however this is by no means essential and actually it is possible to make the rod of a typically thermoplastic plastic material which then results in advantages from the manufacturing technology viewpoint but at the same time the weight of the damping device can be substantially reduced.

A first preferred embodiment of the damping device according to the invention is characterised in that the guide element comprises at least one, preferably two, slits, which are arranged opposite one another, run axially and are delimited in both axial directions, in the cylindrical side wall (typically the outer wall) of the exposed region of the attaching sleeve, in which a transverse pin running perpendicularly to the axis of the damping device, which is attached to the rod, or through this, is guided transversely through a through opening.

Alternatively, the guide element can comprise at least one elongate slit, which runs axially and is delimited in both axial directions, in the rod, in which a transverse pin running perpendicularly to the axis of the damping device, which is fixed in the cylindrical side wall of the exposed region of the attaching sleeve for example, by fixing the transverse pin at both its ends in the corresponding wall section of the attaching sleeve or the exposed region of the same), is captured.

The said slit typically has an axial length in the region of 0.5-2 cm, preferably in the range of 0.7-1.5 cm.

The slit preferably in addition preferably has a width in the range of 1-3 mm, preferably in the range of 2 mm.

According to a preferred embodiment, the end of the slit facing the attaching element for attaching in the pole handle or to the outer tube can have a damping element. In fact, it is the case that if the transverse pin comes to the stop in the maximally relaxed situation, this takes place with considerable force and momentum on account of the assistance by the suspension. This leads to a hard stop and to corresponding noise. This can be intercepted by fitting the end of the slit facing the attaching element with a damping. It is also possible to provide the transverse pin with a corresponding damping. The same is possible, i.e. a damping of the lower stop of the slit, with the end of the slit facing away from the attaching element even if these problems do not typically occur there to the same extent.

Such damping can be achieved quite particularly simply by providing an outside circumferential groove in the exposed region of the attaching sleeve which lies at the height of the end of the slit facing the attaching element and thus lies at the upper stop for the transverse pin running in the slit. A damping element can now be inserted in this groove, for example, a rubber ring or an O ring. If the transverse pin now arrives at the upper stop in the slit, it does not impact there on the hard end of the slit but on this damping element. This can comprise a relatively narrow annular damping element with an extension in the axial direction in the range of 0.5-2 mm.

The transverse pin typically consists of metal but can also consist of hard plastic. It can be continuous but can also comprise one or two opposite stubs fixed in the corresponding component.

The transverse pin preferably has a circular, rectangular or square cross-section. In addition, said pin preferably has a diameter or a width which is somewhat smaller than the width of the guide slit.

A further preferred embodiment is characterised in that the attaching element has a sleeve for the attachment, for example, in a pole handle, which sleeve at least partially grips around the outside of the attaching sleeve and which slides on the outer side thereof leading into the exposed region thereof when the mechanism is compressed. A further guidance of the two movable elements relative to one another can thus be ensured and in addition, the axial length of the attachment of the attaching elements on the outer tube or on the pole handle can be enlarged. The exposed region therefore is then only actually completely exposed in the relaxed state whereas in the completely compressed state typically only a flange is exposed which serves to provide a stop for insertion of the attaching sleeve in the inner tube. Furthermore, with this design the rod can be made relatively simply of metal and this sleeve made of a plastic so that an optimal material combination is possible.

A quite particularly preferred embodiment of the damping device according to the invention is characterised in that the attaching element and the exposed region of the attaching sleeve are configured displaceably at least partially intermeshing in the axial direction so that an extremely compact design can be achieved in the axial direction which in particular is of great advantage with a mounting in the pole handle. This preferred embodiment is accordingly specifically characterised in that at least when the damping device is in the tensioned state (but preferably also to a small extent when the damping device is in the relaxed state), and attaching sleeve and attaching element are in maximal proximity, the attaching element and the exposed region at least partially intermesh.

In this case and for this purpose, preferably the exposed region and the attaching element have corresponding axially running, elongated slit-like guide recesses and circumferentially interposed axial web-like or rod-like or rib- or comb-shaped guide regions formed by these guide recesses and each forming the radial outer wall. At the same time the guide recesses of the attaching element are configured so that they come into in displaceable engagement with the axial guide regions of the exposed region and the guide recesses of the exposed region come into displaceable engagement with the axial guide regions of the attaching element. The side walls of the corresponding element in this case slide on one another. Thus, for example, when viewed in cross-section, these axial guide regions in the attaching element are configured in the form of, for example, four axial fingers (guide regions) each extending only over a certain angular section and extending downwards from a closed head region of the attaching element, which engage slidingly in corresponding axial grooves (guide recesses) in the exposed region. Preferably the axial length of the guide recess is substantially the same as the length of the guide regions so that a closed cylindrical circumferential surface is formed by the exposed region and the attaching element pushed into one another substantially when the damping device is completely pushed together (tensioned).

The guide recesses or the guide regions typically have an axial length in the range of 0.5-2 cm, preferably in the range of 0.7-1.5 cm. The exposed region and the attaching element preferably each have at least two axial guide regions and two axial guide recesses, preferably at least three of both, in particular at least four of both, as explained in the above example and shown in FIGS. 2 and 3. Preferably these regions have an axial length which is at least 50%, preferably at least 75%, particularly preferably at least 80% of the total axial length of the attaching element and/or the exposed region, that is, attaching element and exposed region preferably substantially intermesh when the damping device is pushed together.

A further preferred embodiment is characterised in that the end of the rod facing the floor is in direct contact with the spring element, preferably with an elastomer spring which either forms the spring element as a whole or is part thereof.

The spring element preferably further comprises a structure in which a serial arrangement of spring elements comprising at least one elastomer spring and one spiral spring is provided between the floor and the said end. Particularly preferably comprises a serial arrangement consisting of the following sequence of elements: first elastomer spring in direct contact with the end of the rod followed in the direction of the floor by a spiral spring followed in the direction of the floor by at least one further elastomer spring which for its part rests with its underside on the base. The spring elements preferably have a diameter which is only insignificantly smaller than the inside diameter of the recess in the attaching sleeve but in the case of the elastomer spring is sufficiently smaller so that the required suspension effect is ensured. In the transition region between elastomer spring and spiral spring, guide elements can be provided which at least partially engage in the interior of the spiral spring in the axial direction and on the other side provide a contact surface for the elastomer spring. Preferably no further element is disposed between elastomer spring and the end of the rod and specifically because the rod is made of plastic, this end of the rod can readily serve as a direct contact surface for the elastomer spring which brings with it a further improvement in terms of manufacturing technology and weight. The elastomer spring can, for example, comprise a polyurethane spring element in the form of a foam element, typically having an axial height in the range of 5-15 mm and a diameter which is only insignificantly less than the inside diameter of the blind hole in the recess in the attaching sleeve.

An even more extensive torsional stability can be achieved whereby the rod, at least in that section which is guided through an appropriate corresponding axial opening formed with a similar non-circular cross-section in the exposed region, has a non-circular cross-section, preferably a rectangular or square cross-section. In particular when the attaching element is configured as an adjustable clamping element and large torques are exerted when releasing the adjustment, these torsional forces which must otherwise be completely intercepted, for example, by the above-mentioned transverse pin, can thus be better absorbed.

A further preferred embodiment is characterised in that the attaching element comprises an adjustable clamping device or spreading device with which the first tube segment can be attached detachably or adjustably in the pole handle or a second tube segment having a larger inside diameter.

This preferably comprises a spreading device which is provided rotatably on a screw attached in a rotationally fixed manner on or in the rod at least in components.

Further preferably, the spreading device comprises an inner element mounted rotatably on the screw by means of an internal thread with a single outer cone which widens towards the damping device and a spreading element which receives this inner element in an inner space, with a corresponding inner cone which expands towards the damping device having substantially the same slope as the outer cone and adapted thereto. The spreading element is movable along the axial direction without rotational movement within the framework of a small play (typically in the range of 0.1-5 mm, preferably in the range of 0.3-3 mm) between a lower axial stop and an upper stop.

Further preferably the spreading element has at least one axial slit, in which wings formed on the inner element engage at least partially displaceably in the axial direction. Preferably there are two such slits in the spreading element, an axially completely continuous slit and a slit which is interrupted in a shoulder region on the opposite side. This spreading element can thus be folded out to a certain extent where the non-continuous slit acts to a certain extent as a hinge in the non-continuous region.

In other words, in such a damping device the spreading device preferably sits on a screw having an external thread attached in a rotationally fixed manner to the rod. Such a screw is preferably made of a metal material and has an external thread in that region where the inner element is rotatably mounted. Preferably such a screw is let in and fastened (for example glued in or injected) in an axial blind hole provided for this screw in the rod.

Such a screw preferably has at the end opposite the attaching sleeve, an upper stop element for a spreading element, preferably in the form of a screw head and particularly preferably, on the other side the rod has a circumferential flange formed integrally with the rod at the free end facing the screw, preferably as lower stop element for a spreading element of the spreading device.

The rod preferably consists of a thermoplastic plastic material selected from the group: polyamide, polyester, polycarbonate, polyethylene, polypropylene or a combination/blend thereof, optionally formed in fibre-reinforced form (for example, glass fibres, carbon fibres etc. also particle-shaped fillers are possible), wherein this preferably comprises polyamide.

The attaching sleeve is preferably formed integrally and consists of a thermoplastic plastic material selected from the group: polyamide, polyester, polycarbonate, polyethylene, polypropylene or a combination/blend thereof, optionally formed in fibre-reinforced form (for example, glass fibres, carbon fibres etc. also particle-shaped fillers are possible), wherein this preferably comprises polyamide.

Attaching sleeve and/or attaching element can, however also consists of metal, for example, light metal such as aluminium or from an aluminium alloy (e.g. Al/Mg alloy) or have a corresponding coating or sleeve for contact with the tube.

The attaching element preferably has an axial length in the range of 1-4 cm, preferably in the range of 1.5-3 cm.

The exposed region preferably has an axial length in the range of 0.5-4 cm, preferably in the range of 1.5-3 cm.

The attaching section for its part preferably has an axial length in the range of 2-10 cm, preferably in the range of 4-7 cm.

Normally and preferably the floor of the recess in the attaching element for the rod or the suspension element is configured to be closed. However, it can also have a central axial opening as long as a sufficient contact surface for the spring element is still provided.

Accordingly, such a central axial opening should have a diameter which is substantially less than the inside diameter of the recess, thus, for example a diameter of less than 2 mm, preferably of less than 1 mm.

Preferably the rod and the attaching element are formed integrally and the attaching element is firmly fastened in the pole handle or in the first tube segment by means of a connection as a tight fit, and/or as a force fit and/or adhesive bond.

The present invention further relates to a trekking, ski, hiking, or Nordic walking pole having a damping device as described above, wherein the pole has a pole handle with an axial recess for attaching a pole tube and wherein the damping device is attached in this axial recess in the region near the handle head with the attaching element and the pole tube with its upper free end is attached (for example, force fit and/or adhesive bond such as for example gluing) in the attaching section (surrounding) the attaching sleeve.

In addition, the present invention relates to a trekking, ski, hiking, or Nordic walking pole having a damping device as described above, wherein the pole has at least two tube segments arranged axially displaceably to one another and wherein the damping device is attached in a first tube section with a smaller (outside) diameter by means of the attaching section and in a second tube segment having a larger (inside) diameter by means of the attaching element which is preferably configured as a detachable spreading device.

Further embodiments are specified in the dependent claims.

### BRIEF DESCRIPTION OF THE DRAWINGS

Preferred embodiments of the invention are described in detail hereinafter with reference to the drawings which merely serve for explanation and are not to be interpreted as restrictive. In the drawings:

FIG. 1 shows a first exemplary embodiment of a damping device in different views, thus in a) in a pole handle in the relaxed state, in b) in a pole handle in the tensioned state; in c) in a perspective view, in d) in a side view when viewed along the running direction of the guide pin; and in e) in an axial section in a plane through the guide pin;

FIG. 2 shows a second exemplary embodiment of a damping device in different views, thus in a)-d) in the relaxed state, where a) shows a side view in a view along the running direction of the guide pin, b) shows a side view in a view perpendicular to the running direction of the guide pin, c) shows an axial section perpendicular to the running direction of the guide pin and d) shows a perspective view, and in e)-h) in the tensioned state, where e) shows a side view in a view along the running direction of the guide pin, f) shows a side view in a view perpendicular to the running direction of the guide pin, g) shows an axial section perpendicular to the running direction of the guide pin and h) shows a perspective view;

FIG. 3 shows a third exemplary embodiment of a damping device in different views in the relaxed state, where a) shows a side view in a view along the running direction of the guide pin, b) shows a side view in a view perpendicular to the running direction of the guide pin, c) shows an axial section perpendicular to the running direction of the guide pin and d) shows a perspective view;

FIG. 4 shows a fourth exemplary embodiment of a damping device with adjustable clamping element, where a) shows a side view, b) shows another side view turned through 90° to view a), c) shows a section along the line A-A in Figure a), d) shows a section along the line B-B in Figure b) and an outside view of an adjustable tube in the transition section with such a damping device, g) shows an axial section through such a transition section in the relaxed state and h) shows an axial section through such a transition section in the tensioned state;

FIG. 5 shows a fifth exemplary embodiment of a damping device with adjustable clamping element, where a) shows a side view, b) shows another side view turned through 90° to view a), c) shows a section along the line A-A in Figure a), d) shows a section along the line B-B in Figure b); and

FIG. 6 shows a sixth exemplary embodiment of a damping device, where a) shows a side view, b) shows a section along the line A-A in Figure a), c) shows a perspective view from below; d) shows a perspective view of the element with the rod without sleeve and e) shows an exploded view.

### DESCRIPTION OF PREFERRED EMBODIMENTS

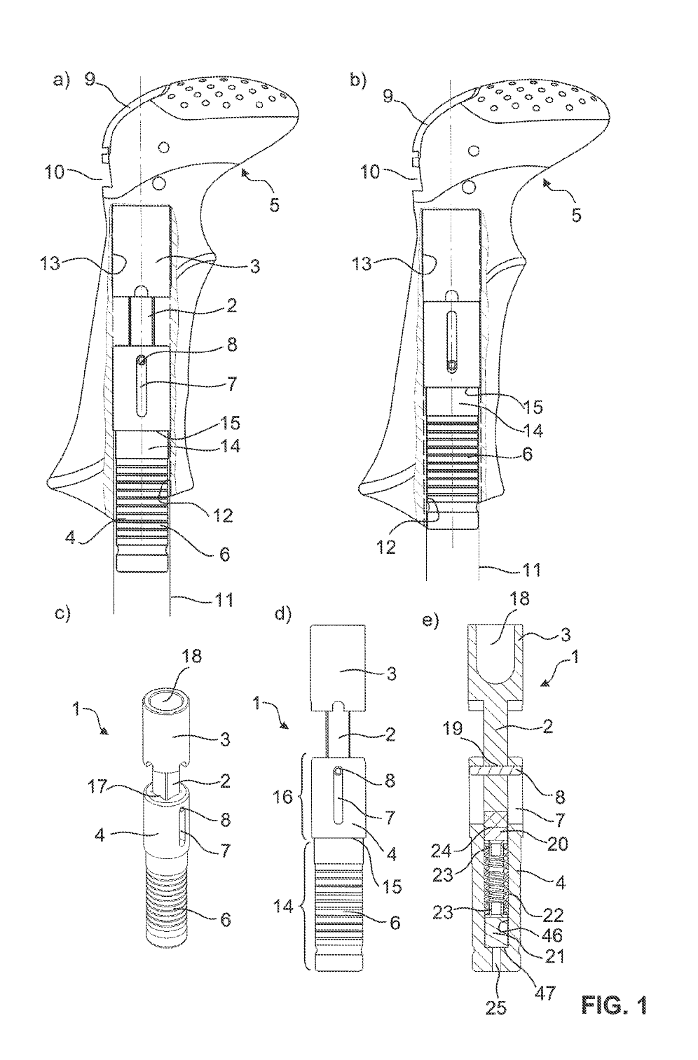

FIG. 1 shows a damping device 1 according to a first exemplary embodiment. This comprises a damping device which has an attaching element 3 which is attached fixedly, i.e. this does not comprise spreading clamping or similar for variable adjustability. Such a damping device can, for example, be disposed in the pole handle as shown in FIGS. 1a or b in the relaxed or tensioned (completely pushed together) state. Such damping device which can be disposed substantially completely in the most compact form possible in a pole handle can particularly be of great advantage when either the pole as a whole is not configured to be telescopically adjustable as a whole or is configured to be telescopically adjustable from a plurality of tube segments which can be pushed into one another but the fixing of the axial relative position of these tube segments is achieved for example by external clamping mechanisms which do not allow suspension.

The tube handle 5 shown here accordingly has a substantially axial recess 12 formed from below in the form of a blind hole, which has a circular cross-section and extends as far as possible upwards into the tube handle. In the head region the tube handle has a clamping device 9 for a hand loop, this is typically passed through a recess 10 in the head handle and clamped in different positions or length settings by a flap or another type of clamping.

As can be identified in particular in the views according to FIGS. 1c and d, the damping device has an attaching sleeve which has an attaching section 14 in the lower region. This attaching section 14 goes over towards the top into an exposed region 16 having a somewhat larger diameter so that a circumferential shoulder 15 is formed between the sections 14 and 16. The pole tube 11 is pushed from below onto the attaching section 14 and brought to a stop with the shoulder 15 and fixed in this position. To this end the pole tube 11 substantially has an inside diameter which corresponds to the outside diameter of the section 14. For improved attachment the attaching section 14 can have a ribbed surface 7 and optionally special constrictions or similar. The pole tube 11 is typically firmly clamped and/or firmly bonded at this attaching section.

When the attaching sleeve 4 is attached thus in the pole tube, the attaching sleeve 4 projects with the exposed region 16 beyond the free end of the pole tube 11. In this exposed region 16 an elongated axial slit 7 is provided in the cylindrical outer wall of this region. A guide pin 8 in the form of a transverse pin 8 typically made of metal is captured in this axial slit. This transverse pin 8 is fixed in a through opening 19 of a rod 2, which is formed integrally with the attaching element 3, and extends laterally in both direction beyond the width of the rod 2, as can be identified in particular in the axial section according to FIG. 1e.

In fact, the attaching sleeve has a blind hole with a floor 47 which extends from above into said sleeve, i.e. there is an inner space 46 with a cylindrical outer wall in the lower region 14 going over into a region having a square cross-sectional area in region 16. A small axial opening 25 can be provided in the floor 47 of this recess 46.

The said rod 2 now runs in an axially displaceable manner in this axial opening 46, where the axial mobility of the rod 2 is restricted by the play inside the slit 7 which the guide pin 8 is allowed. Accordingly, the completely relaxed state as shown in FIG. 1e is defined by an upper position in which the transverse pin 8 comes to a stop with the upper terminating surface of the slit 7. On the other hand, the lower stop of the tensioned state (cf. FIG. 1b) is generally defined by the fact that in this state the lower edge of the attaching element comes to a stop with the upper edge of the region 16 but it is also possible that this stop position is given by a stop of the transverse pin 8 on the lower end of the guide slit 7.

In this case, the rod 2 is only disposed in the upper region of the recess 46, since a spring element is disposed in the lower region. This spring element comprises a sequence composed of an elastomer spring 20 which is in direct contact with the lower contact surface, i.e. the lower end 24 of the rod 2, followed by a spiral spring 22, in turn followed at the lower end by a second elastomer spring 21 which is in contact with the floor 47.

Such a sequence of spring elements has the result that on the one hand, a very good suspension is provided but on the other hand, not too high elasticity, i.e. it is ensured that the recoil is not too high upon impact on the floor, i.e. a suspension is thus obtained with large spring path but low kickback, i.e. with large damping. In order to provide a clearly defined contact surface for the spiral spring on the elastomer springs, there are intermediate elements 23 which engage with a circumferential flange into the interior of the spiral spring over a certain axial section and which have a flat element on the side facing the respective elastomer spring.

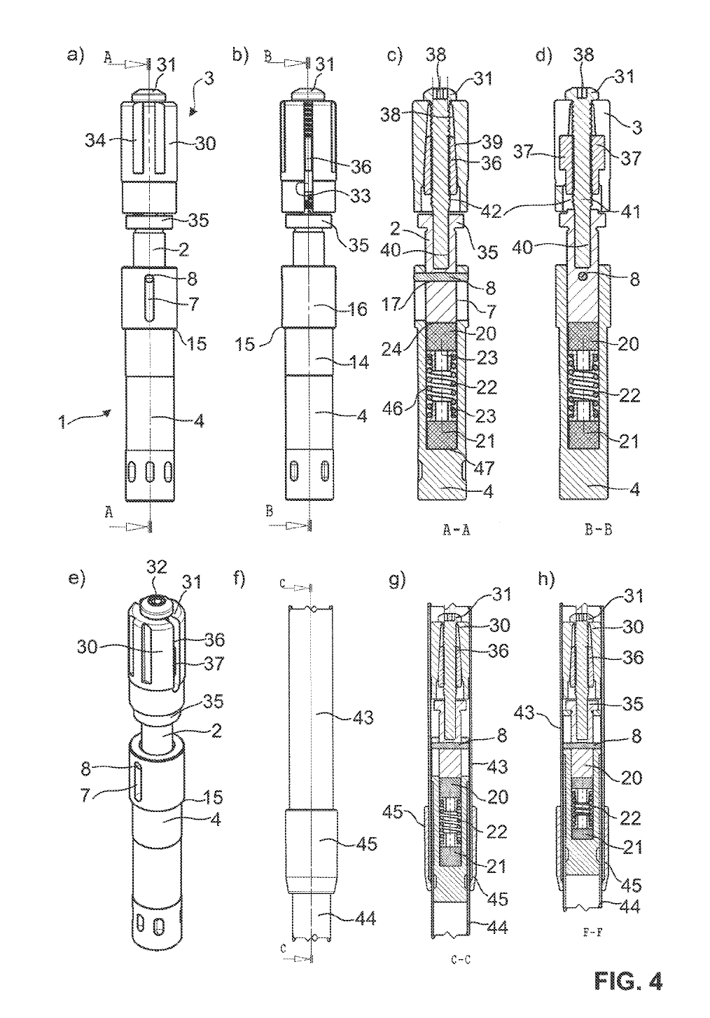

In this case, the rod 2 consisting of a plastic material is not configured to be cylindrical but has a square cross-section. This square cross-section grips through a likewise square through opening 17 in the exposed region 16 and is accordingly guided through this through opening 17. On the one hand due to the arrangement of the transverse pin 8 in the guide pin and on the other hand due to this non-circular configuration of rod 2 and through opening 17, it is ensured that rod and attaching element are mounted displaceably in relation to the attaching sleeve in the axial direction but cannot be turned. This is of great advantage for the stability of the structure and in particular allows, in a modification of the exemplary embodiment according to FIG. 1, the attaching element 3 to be provided not as shown here as an attaching element with an exposed cavity 18 at the top and provided for this purpose to be firmly glued or clamped in the handle in the fastening region 13 but to configure this attaching element in the sense of a spreading device, which can be released by exerting a torsional force. In particular, if the attaching element is configured as such a clamping device as will be explained subsequently in connection with FIG. 4, it can be important that too high torsional forces are not exerted on the guide pin since this can otherwise possibly break or must be excessively dimensioned.

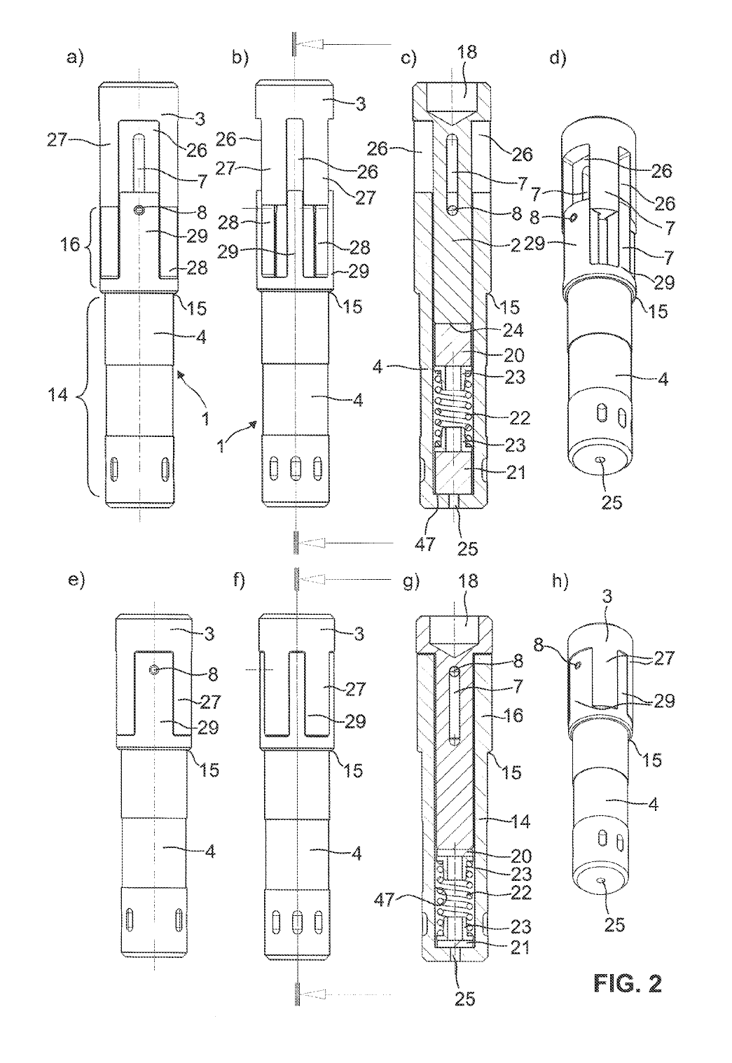

A second exemplary embodiment of the damping device according to the present invention is shown in FIG. 2. This comprises an extremely compact design such as is particularly suitable for direct attachment in a pole handle. The relative arrangement of transverse pin 8 and slit 7 is here reversed to a certain extent compared with the exemplary embodiment according to FIG. 1. Specifically here there is a longitudinal slit 7 in the attaching element 3 or in the rod 2 configured integrally therewith and the transverse pin 8 is mounted in the exposed region 16.

In general the same reference numbers designate the same or functionally equivalent elements such as have already been presented and discussed within the framework of FIG. 1.

In order to ensure the most compact design possible, in this exemplary embodiment the procedure is adopted that the attaching element 3 which is not configured here as a spreading element and the exposed region 16 intermesh as far as possible axially in particular in the completely tensioned state (cf. FIGS. 2e-h). For this purpose the attaching element 3 has four axial guide regions 27 distributed over the circumference, which are separated from one another by four interposed guide recesses 26. These four axial guide regions 27 are interconnected in the head region of the attaching element 3 which is configured to be circumferential. They are also interconnected by the rod 2 disposed at the centre and formed integrally therewith. The axial guide regions 27 form the cylindrical outer surface of the attaching element 3 which comes in contact with the pole handle or a tube section.

Corresponding to this, the exposed region 16 has axial grooves or guide recesses 28 whose cross-sectional area is adapted to the axial guide regions 27 of the attaching element 3. These guide recesses 28 of which four are distributed around the circumference, are for their part separated by four finger-like upwardly extending axial guide regions 29 which are not interconnected at the upper end and accordingly have free ends. The guide pin 8 is attached in a bridging fashion between two opposite free ends of this type.

The axial guide regions 27 therefore run axially displaceably in the axial guide recesses 28 and the axial guide regions 29 run displaceably in the guide recesses 26 in the axial direction. Even in the completely relaxed state (FIGS. 2a-d) attaching element and exposed region still intermesh to some extent, this axial overlap region is typically at least 2 mm, preferably in the region of 3-4 mm. The axial length of the elements 26 and 27 is adapted to the axial length of the elements 29 or 28 so that in the completely tensioned state, i.e. pushed into one another as shown in FIGS. 2e-h, attaching element and exposed region are arranged to be completely intermeshing and are arranged to form a substantially closed cylindrical circumferential surface, where however the circumferential surface of the guide regions 29 should only be slightly radially inwardly offset so that these are displaceable in the tube without friction (axial mobility).

In this exemplary embodiment the upper stop for the relaxed state is predefined by the stop of the transverse pin 8 at the lower end of the slit 7 (cf. in particular FIG. 2c) and the stop of the completely tensioned state, i.e. pushed into one another, is predefined by the stop of the elements 26/29 or 27/28. However, the lower state can alternatively or additionally be set by the stop of the transverse pin at the upper end of the slit 7 as can be seen from FIG. 2g.

This exemplary embodiment is not only maximally compact but can also be mounted particularly easily because the transverse pin 8 is disposed in a region which projects upwards over the attaching region 14. With such a design it is furthermore easily possible to provide a complete locking of the suspension.

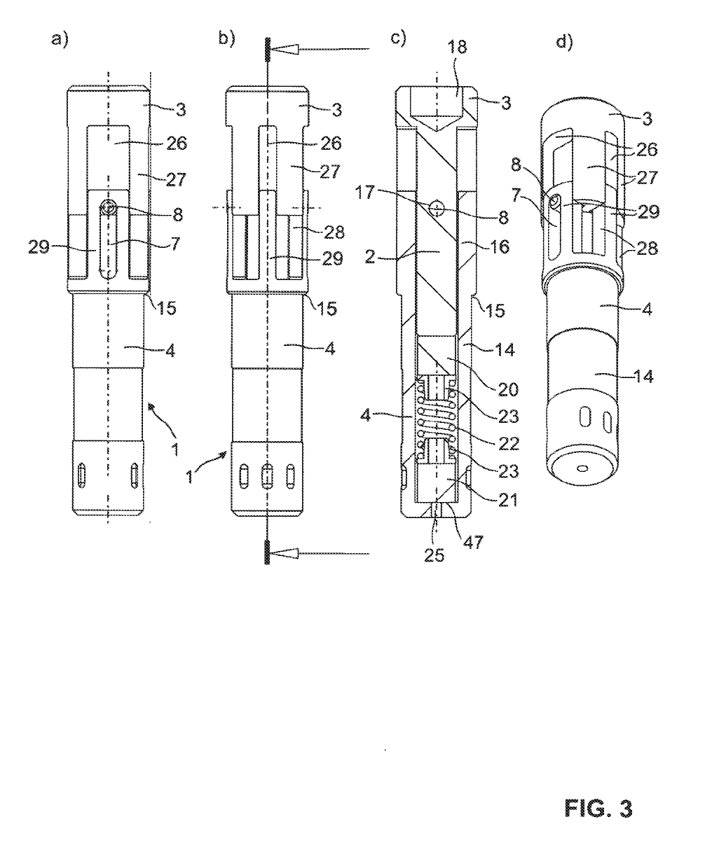

A somewhat modified exemplary embodiment similar to that of FIG. 2 is shown in FIG. 3. Here however, the situation is again similar as in FIG. 1 with regard to slit 7 and transverse pin 8 whereas otherwise the design substantially corresponds to that of FIG. 2.

In other words, the longitudinal slit in the axial direction is again provided in the exposed region 16 and specifically in two opposite axial guide regions 29 and the transverse pin 8 is mounted in a through opening 17 in the rod 2. Accordingly, the upper stop for the relaxed state as shown in FIG. 3, is given by the uppermost possible position of the transverse pin 8 in the slit 7.

A fourth exemplary embodiment of the damping device is shown in FIG. 4. The damping device 1 again has an attaching sleeve 4 which has an attaching section 14 having smaller diameter, going over at a circumferential step 15 into an exposed region 16 having larger diameter. For attachment of such a damping device, a smaller-diameter inner tube 44 is pushed over the region 14 until it stops at the step 15 and is then fixed in this position.

In the exposed region 16 formed integrally with the attaching section 14, there is a longitudinal slit 7 in the cylindrical outer wall in which a transverse pin fixed in an axially running rod 2 in a through opening 17 is captured. The upper stop for the relaxed state is here defined by the upper end of the slit 7, as shown in FIGS. 4a-d. The rod 2 here has a circular cross section and the attaching element is provided as a clamping element for detachable attachment in an outer tube 43. This clamping element has a spreading element 30 which has an inner cone 38 on the inner side which opens towards the inner tube. An inner element 36 mounted on an external thread 42 of a screw 41 by means of an internal thread is disposed rotatably in the inner space formed by this inner cone. This inner element 36 for its part has an outer cone 39 with substantially the same slope as the aforesaid inner cone 38.

This inner element 36 can only be displaced in the axial direction when it turns relative to the screw. In contrast to this, the spreading element 30 is easily moveable in the axial direction, i.e., captured with a certain play between a screw head 31 and a circumferential shoulder 35. Within the limits of this play, the spreading element 30 can be moved to and fro in the axial direction without itself turning.

The spreading element 30 furthermore has a longitudinal slit 33 extending over the complete axial length on one side and on the opposite side this longitudinal slit is not continuous, as can be identified in particular by reference to FIG. 4d. Small radially outwardly extending wings 37 formed on the inner element 36 engage in this longitudinal slit 33. Accordingly, the inner element 36 cannot twist relative to the spreading element but only be displaced in the axial direction. If the inner element 36 is pushed upwards by turning of the screw 41 in such a clamping device, the lateral jaws of the spreading element spread out and a clamping on the inner wall of the outer tube 43 is accomplished. For better clamping, indentations 34 can be provided in the spreading element.

In order that such a clamping device functions efficiently, the inner element 36 must be mounted rotatably on the external thread 42 so that it runs as easily as possible. If friction here is too great, as a result of the great torsion when attempting to fix the clamping mechanism, the spreading element 30 also turns and a clamping cannot be produced. Accordingly it is important that the external thread 42 is highly precise and high-strength, which is why the screw 41 must typically consist of metal. However, it is not necessary that the rod 2 must also be made of metal for this reason and specifically it is found to be a great advantage if this screw 41 is configured as a separate metal element which is as short as possible and fixed in a blind hole 40 in the rod 2 in a positionally and rotatably fixed manner, for example, by overmoulding. This blind hole 40 extends just so far that it leaves the through opening 17 untouched for the transverse pin 8. Accordingly the rod 2, which is made of a plastic material and is therefore substantially lighter and has better availability in terms of production technology, is configured so that in the upper region to a certain extent it provides a sleeve for receiving the screw 41 and via the flange 35 a stop for the spreading device, serves for fastening the transverse pin in the central region and with the lower terminating surface 24 which projects into the attaching sleeve, serves as a stop for the spring element. Here also the spring element is configured as a series of elastomer spring 20, spiral spring 22 and followed on the floor 47 of the recess 46 by another elastomer spring 21. Here also guide elements 23 are provided at the transitions from spiral spring 22 to the corresponding elastomer spring 20 or 21.

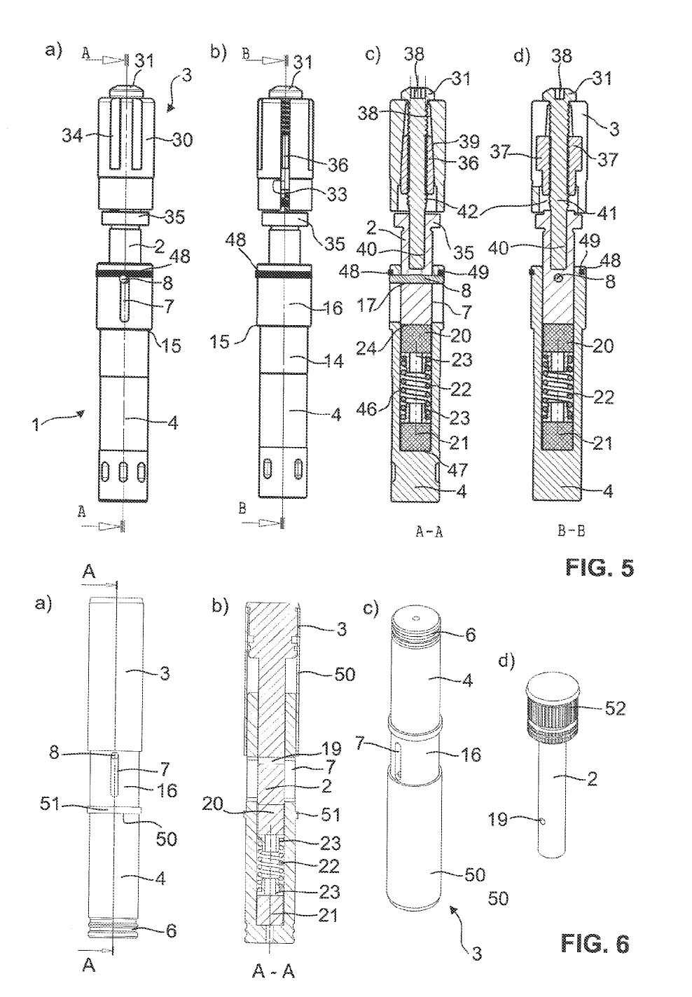

FIG. 5 shows another exemplary embodiment which corresponds in terms of the elements designated by the same reference numbers and their mode of operation to that shown in FIG. 4 and which has already been described in detail in connection with this figure. This further exemplary embodiment differs from that of FIG. 4 in particular in that the upper stop of the transverse pin 8, i.e. the stop of the transverse pin 8 in the guide slit 7 which delimits the relaxed position and faces the attaching element 3 has damping. This damping is achieved by an annular damping element 48 which is disposed in a circumferential groove 49 arranged in the region 16 at the appropriate axial height. The groove lies substantially at the height of the upper stop which is formed by the slit 7 and has a width or depth so that the damping element 48 is let into this groove substantially completely and does not project unnecessarily over the cylindrical outer surface of the region 16. The slit 7 still has an upper end to a certain extent but lies so that the transverse pin can only come in contact with this upper end when it has at least partially or even substantially completely squeezed the damping element in the corresponding circumferential position. If during relaxation, (this relaxation is typically spring-assisted and accordingly takes place with violent momentum), the transverse pin therefore arrives at the upper stop, it does not impinge upon the hard stop gate of the slit 7 but the damping element 48, which has the result that on the one hand no hard impact takes place which is perceived as unpleasant by the user and on the other hand, no annoying clinking noise occurs. This comprises an extremely simple and malfunction-resistant design which can also be assembled easily (simply pulling a rubber ring over the region 16 and relaxing snapping into the groove 49) which produces a great effect with simple constructive means.

The damping element 48 can, for example, comprise an O-ring with corresponding radius and in this case the groove 49 can be configured as a semi-circular groove in the lower region. However, the damping element 48 can also have a rectangular or square cross-section so that such an element can then preferably be inserted into a corresponding rectangular groove 49.

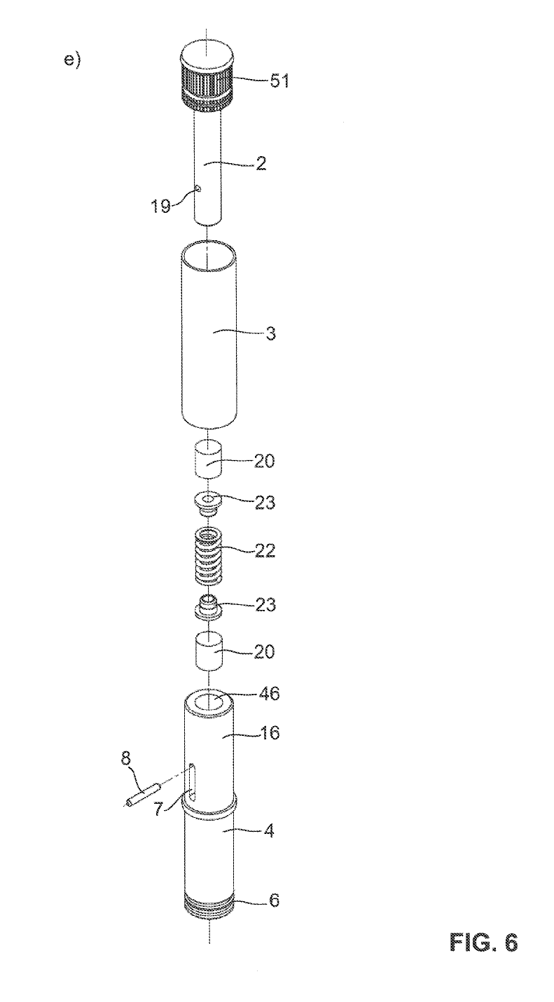

A further preferred embodiment of a damping mechanism, in particular for attachment in a pole handle, is given in FIG. 6 is different views. Here also the same reference numbers designate the same or at least functionally equivalent elements such as, for example, in FIG. 1. In this case the attaching element 3 has a multipart design. On one side there is the integrally formed element, typically made of metal or plastic, with rod 2 and a head element 52 (cf. in particular FIG. 6d) where this head element can have an axially running toothed structure in the circumferential cylindrical region. Attached to this is a circular cylindrical sleeve 50 which then also serves to attach the attaching element, for example, in the recess of the pole handle. The sleeve 50 has an appreciable axial extension and with its one end comes to a stop with a circumferential flange at the head-side end of the head element 52 and at the other end embraces the exposed region in such a manner that typically the slit 7 is only exposed in the completely relaxed position (cf. FIG. 6a). Accordingly the attaching sleeve 4 is configured so that it has a circumferential flange 51 with low axial height as shoulder 15 for the stop of the inner tube (not shown in FIG. 6). The underside of this flange the serves as stop 15 and the upper side, insofar as the stop of the attaching element 3 is not delimited by the slit 7, serves as stop for the lower edge of the sleeve 50. An attaching region which is axially as long as possible can then be provided for the attaching element 3 and since the exposed region 16 per se only needs to be accessible in the relaxed position, no practical disadvantages are obtained as a result. In addition, due to its sliding bearing against the cylindrical outer surface of the region 16, the sleeve 50 results in an additional guidance and stabilisation of the mechanism.

### REFERENCE LIST

1 Damping device
2 Rod
3 Attaching element, clamping element
4 Attaching sleeve
5 Pole handle
6 Ribbed surface of 4
7 Guide slit
8 Guide pin
9 Clamping device for hand loop
10 Recess for clamping device
11 Pole tube
12 Recess in 5 for 11/1
13 Attaching region for 3 in 12
14 Attaching section of 4
15 Shoulder
16 Exposed region of 4
17 Through opening for 2 in 4
18 Exposed cavity in 3
19 Transversely running through opening in 2 for 8
20 Upper elastomer spring
21 Lower elastomer spring

22 Spiral spring

23 Guide element/supporting element for 22 at 20/21
24 Lower contact surface of 2
25 Axial opening
26 Guide recesses in 3
27 Axial guide regions of 3
28 Guide recesses in 15
29 Axial guide regions of 15
30 Spreading element
31 Screw head
32 Multi-edge recess
33 Longitudinal slit
34 Indentation
35 Shoulder of 2
36 Inner element
37 Axial wing
38 Inner cone of 30
39 Outer cone of 36
40 Blind hole for screw in 2
41 Screw
42 External thread of 41
43 Outer tube
44 Inner tube
45 Sleeve
46 Inner space of 4
47 Floor of 46
48 Damping element for 8, circumferential ring of elast. material, rubber ring
49 Circumferential groove in 16
50 Sleeve
51 Flange
52 Head element

1-15. (canceled)

16. A damping device for a pole, comprising:
an attaching sleeve by means of which the damping device is attached to a first tube segment by inserting and attaching therein, and
an attaching element by means of which the damping device is attached to a pole handle or a second tube segment having a larger inner diameter than the first tube segment,
wherein the attaching element is thereby movably supported in a spring-loaded manner in the axial direction with respect to the attaching sleeve,
wherein a rod connected to or integral to the attaching element runs axially and is axially movably supported in the attaching sleeve and extends into an inner chamber in the attaching sleeve open towards the attaching element,
wherein said inner chamber is designed as a blind hole and at least one spring element is disposed between a floor of said inner chamber and a free end of the rod,
wherein the attaching sleeve comprises an attaching segment forming an end opposite the attaching element and substantially lying completely within the first tube segment, and an exposed region facing the attaching element and protruding past a free end of the first tube segment,
wherein at least one guide element is also disposed in said exposed region and both bounds an axial movability of the attaching sleeve and attaching element in an axial direction and substantially prevents a relative rotation of said two elements, and
wherein the rod consists of a plastic material or of metal at least in the region engaging with the attaching sleeve.

17. The damping device according to claim 16, wherein the guide element comprises at least two slits, which are arranged opposite one another, run axially and are delimited in both axial directions, in the cylindrical side wall of the exposed region of the attaching sleeve, in which a transverse pin running perpendicularly to the axis of the damping device, which is attached to the rod, is captured, or
wherein the guide element comprises at least one slit, which runs axially and is delimited in both axial directions, in the rod, in which a transverse pin running perpendicularly to the axis of the damping device, which is fixed in the cylindrical side wall of the exposed region of the attaching sleeve, is captured.

18. The damping element according to claim 16, wherein the attaching element and the exposed region at least partially intermesh at least when the damping device is in the tensioned state and attaching sleeve and attaching element are in contact or in maximal proximity.

19. The damping device according to claim 18, wherein the exposed region and the attaching element each have at least two axial guide regions and two axial guide recesses.

20. The damping element according to claim 16, wherein the end of the rod facing the floor is in direct contact with the spring element.

21. The damping element according to claim 16, wherein the rod has a non-circular cross-section, at least in that section which is guided through a corresponding axial opening in the exposed region.

22. The damping element according to claim 16, wherein the attaching element comprises a spreading device with which the first tube segment can be attached detachably or adjustably in the pole handle or a second tube segment having a larger inside diameter.

23. The damping device according to claim 22, wherein the spreading device is provided with an external thread, on a screw attached in a rotationally fixed manner on the rod, wherein this screw is let in and fastened in an axial blind hole provided for this screw in the rod.

24. The damping element according to claim 16, wherein the rod consists of a thermoplastic plastic material selected from the group consisting of: polyamide, polyester, polycarbonate, polyethylene, polypropylene or a combination or fibre-reinforced form thereof.

25. The damping element according to claim 16, wherein the attaching sleeve is formed integrally and consists of metal, and/or of a thermoplastic plastic material selected from the group consisting of: polyamide, polyester, polycarbonate, polyethylene, polypropylene or a combination or in fibre-reinforced form thereof.

26. The damping element according to claim 16, wherein the attaching element has an axial length in the range of 1-4 cm, and wherein the exposed region has an axial length in the range of 0.5-4 cm.

27. The damping element according to claim 16, wherein the floor is configured to be closed or at most has a central axial opening having a diameter of less than 2 mm.

28. The damping element according to claim 16, wherein the rod and the attaching element are formed integrally and the attaching element is firmly fastened in the pole handle or in the first tube segment by means of a connection as a tight fit, and/or as a force fit and/or adhesive bond.

29. A trekking, ski, hiking, or Nordic walking pole having a damping device according to claim 16, wherein the pole has a pole handle with an axial recess for attaching a pole tube and wherein the damping device is attached in this axial recess in the region near the handle head with the attaching element and the pole tube is attached with its upper free end surrounding the attaching sleeve in the attaching section.

30. A trekking, ski, hiking, or Nordic walking pole having a damping device according to claim 16, wherein the pole has at least two tube segments arranged axially displaceably to one another and wherein the damping device is attached in a first tube section with a smaller diameter by means of the attaching section and in a second tube segment having a larger diameter by means of the attaching element which is configured as a detachable spreading device.

31. The damping element according to claim 16, wherein it is for a trekking, ski, hiking, or Nordic walking pole.

32. The damping device according to claim 16, wherein the guide element comprises at least two slits, which are arranged opposite one another, run axially and are delimited in both axial directions, in the cylindrical side wall of the exposed region of the attaching sleeve, in which a transverse pin running perpendicularly to the axis of the damping device, which is attached to the rod, is captured, or
wherein the guide element comprises at least one slit, which runs axially and is delimited in both axial directions, in the rod, in which a transverse pin running perpendicularly to the axis of the damping device, which is fixed in the cylindrical side wall of the exposed region of the attaching sleeve, is captured,
wherein in at least one of the stop positions of the transverse pin in the slit, at least one damping element, in the form of a circumferential ring made of elastic material, let into a groove of the exposed region is provided.

33. The damping element according to claim 16, wherein the attaching element and the exposed region at least partially intermesh at least when the damping device is in the tensioned state and attaching sleeve and attaching element are in contact or in maximal proximity, wherein the exposed region and the attaching element have corresponding axially running guide recesses and circumferentially interposed axial guide regions formed by these guide recesses and forming the radial outer wall, and at the same time the guide recesses of the attaching element are in displaceable engagement with the axial guide regions of the exposed region and the guide recesses of the exposed region are in displaceable engagement with the axial guide regions of the attaching element.

34. The damping device according to claim 18, wherein the exposed region and the attaching element each have at least three axial guide regions or at least four axial guide regions and at least three axial guide recesses, or at least four axial guide recesses, wherein these regions have an axial length which is at least at least 80% of the total axial length of the attaching element and/or the exposed region.

35. The damping element according to claim 16, wherein the end of the rod facing the floor is in direct contact with an elastomer spring which either forms the spring element as a whole or is part thereof,
or wherein the spring element further comprises a structure in which a serial arrangement of spring elements comprising at least one elastomer spring and one spiral spring is provided between the floor and the said end, wherein this comprises a serial arrangement consisting of the following sequence of elements: first elastomer spring in direct contact with the end of the rod followed towards the floor by a spiral spring followed towards the floor by at least one further elastomer spring which for its part rests with its underside on the floor.

36. The damping element according to claim 16, wherein the rod has a rectangular or square cross-section, at least in that section which is guided through a corresponding axial opening in the exposed region.

37. The damping element according to claim 16, wherein the attaching element comprises a spreading device with which the first tube segment can be attached detachably or adjustably in the pole handle or a second tube segment having a larger inside diameter, wherein this comprises a spreading device which is provided rotatably on a screw attached in a rotationally fixed manner on the rod, and wherein furthermore the spreading device comprises an inner element mounted rotatably on the screw by means of an internal thread with a single outer cone which widens towards the damping device and a spreading element which receives this inner element in an inner space, with a corresponding inner cone which expands towards the damping device, which spreading element is movable along the axial direction without rotational movement within the boundaries of a small play between a lower stop and an upper stop, wherein the spreading element has at least one axial slit, in which wings formed on the inner element engage at least partially displaceably in the axial direction.

38. The damping device according to claim 22, wherein the spreading device is provided with an external thread, made of a metal material, on a screw attached in a rotationally fixed manner on the rod, wherein this screw is let in and fastened in an axial blind hole provided for this screw in the rod and at the end opposite the attaching sleeve has an upper stop element for a spreading element, in the form of a screw head and wherein the rod has a circumferential flange formed integrally with the rod at the free end facing the screw, as lower stop element for a spreading element of the spreading device.

39. The damping element according to claim 16, wherein the rod consists of polyamide.

40. The damping element according to claim 16, wherein the attaching sleeve is formed integrally and consists of light metal, and/or a thermoplastic plastic polyamide.

41. The damping element according to claim 16, wherein the attaching element has an axial length in the range of 1.5-3 cm, and wherein the exposed region has an axial length in the range of 1.5-3 cm, and wherein the attaching section has an axial length in the range of 4-7 cm.

42. The damping element according to claim 16, wherein the floor is configured to be closed or at most has a central axial opening having a diameter of less than 1 mm.
